(19) United States
(12) Patent Application Publication
(10) Pub. No.: US 2010/0138113 A1
(43) Pub. Date: Jun. 3, 2010

(54) CONTROL SYSTEM AND METHOD FOR PROTECTING INFANT AND CHILD OCCUPANTS IN VEHICLE

(75) Inventors: Eun Ryung Lee, Daegu (KR); Jae Young Kim, Daegu (KR); Kee koo Kwon, Daegu (KR); Joon Hak Bang, Daegu (KR); Jong Uk Kim, Daegu (KR); Sung Ho Ahn, Daegu (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/549,946

(22) Filed: Aug. 28, 2009

(30) Foreign Application Priority Data
Dec. 3, 2008 (KR) 10-2008-0121898

(51) Int. Cl. B60R 21/015; B60Q 1/00

(52) U.S. Cl. 701/45; 340/438; 340/457.1

(57) ABSTRACT

Provided are a control system and method for protecting a child occupant of a vehicle. The control system includes a detecting unit, a monitoring unit, and a control unit. The detecting unit detects occupant data including weights of occupants and deployed lengths of seat belts. The monitoring unit determines whether the occupant is a child, whether the occupant has a seat belt on, and an occupant position based on the detected occupant data to generate occupant status data according to the determined results. The control unit controls a vehicle peripheral device according to the occupant status data when the occupant status data is received.

### CROSS-REFERENCE TO RELATED APPLICATIONS

This application claims priority under 35 U.S.C. §119 to Korean Patent Application No. 10-2008-0121898, filed on Dec. 3, 2008, in the Korean Intellectual Property Office, the disclosure of which is incorporated herein by reference in its entirety.

### TECHNICAL FIELD

The following disclosure relates to a control system and method for protecting infant and child occupants in a vehicle, and in particular, to a control system and method for detecting whether there are infant and child occupants in a vehicle and the positions of infant and child occupants, and protecting the infant and child occupants, according to the detected results.

### BACKGROUND

To protect infant or child occupants of a vehicle, a user directly installs a child seat or enables a child lock, or the vehicle detects the presence of infants and children to automatically lock doors and windows or automatically adjust a passenger side airbag to reduce the risk of an airbag accident for an infant or child seated in the front passenger seat.

However, methods, other than that in which a child seat is installed, may provide minimal protection for infants and children, but have limitations for active infants and children, and also, do not unitively protect infants and children with an entire vehicle system.

As a result, occupant classification systems that determine whether an occupant of a vehicle is an adult or a child are being developed.

FIG. 1 is a block diagram of a related art occupant classification system.

Referring to FIG. 1, a related art occupant classification system includes a weight sensor 10, an electric field sensor 20, a camera 30, and a control unit 40.

The weight sensor 10, the electric field sensor 20, and the camera 30 are installed at a front passenger seat. Thus, the weight sensor 10 and the electric field sensor 20 detect an occupant seated in the front passenger seat and the camera 30 photographs the occupant seated in the front passenger seat to output a detection or video signal including occupant data.

The control unit 40 determines whether the occupant is an adult or child based on the occupant data included in the received detection or video signal.

However, such a fragmentary occupant classification system does not account for infant and child occupants, seat belt who have a greater aversion to wearing seat belts than adults and are thus more likely not to wear them seat belt.

Therefore, to protect active infants and children within a vehicle, there is provided a vehicle safety system that can more precisely detect the occupancy of infants and children in consideration of their traits, in order to actively protect infant and child occupants.

### SUMMARY

According to an aspect, a control system for protecting a child riding in a vehicle includes: a detecting unit detecting occupant data including a weight of an occupant and a pulled-out length of a seat belt; a monitoring unit determining whether the occupant is a child, whether the occupant fastens the seat belt, and an occupant position based on the detected occupant data to generate occupant status data according to the determined results; and a control unit controlling a vehicle peripheral device according to the occupant status data when the occupant status data is received.

According to another aspect, a control method for protecting a child riding in a vehicle method includes: obtaining occupant data comprising a weight of an occupant and a pulled-out length of a seat belt;determining whether the occupant is the child, whether the occupant fastens the seat belt, and an occupant position based on the obtained occupant data to generate occupant status data according to the determined results; and controlling a vehicle peripheral device according to the generated occupant status data.

### BRIEF DESCRIPTION OF THE DRAWINGS

FIG. 1 is a block diagram of a related art occupant classification system.

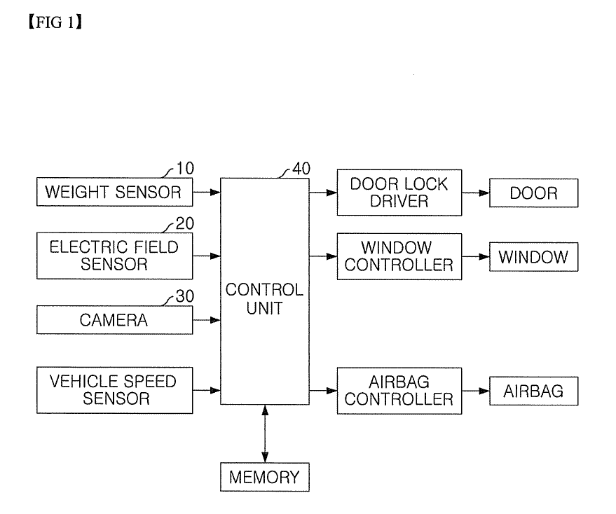

FIG. 2 is a block diagram of a control system for protecting infant and child occupants of a vehicle according to an exemplary embodiment.

FIG. 3 is a block diagram illustrating a detecting unit of FIG. 2.

FIG. 4 is a block diagram of occupant detection sensors installed in seats of a vehicle.

FIG. 5 is a block diagram illustrating a control unit of FIG. 2.

FIG. 6 is a block diagram illustrating a drive unit of FIG. 2.

FIG. 7 is a block diagram illustrating peripheral devices of the vehicle of FIG. 2.

FIG. 8 is a flowchart illustrating a process for distinguishing occupants and occupant statuses through a monitoring unit according to an exemplary embodiment.

FIG. 9 is a flowchart illustrating a control method for protecting infant and child occupants of a vehicle according to an exemplary embodiment.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, for briefness of description, infants and younger children who require additional protection within a vehicle will be referred to as children. Therefore, it will be understood that the term “child” used in this exemplary embodiment includes infants, toddlers, and younger children such as elementary school pupils, unless descriptions specifically denote older children.

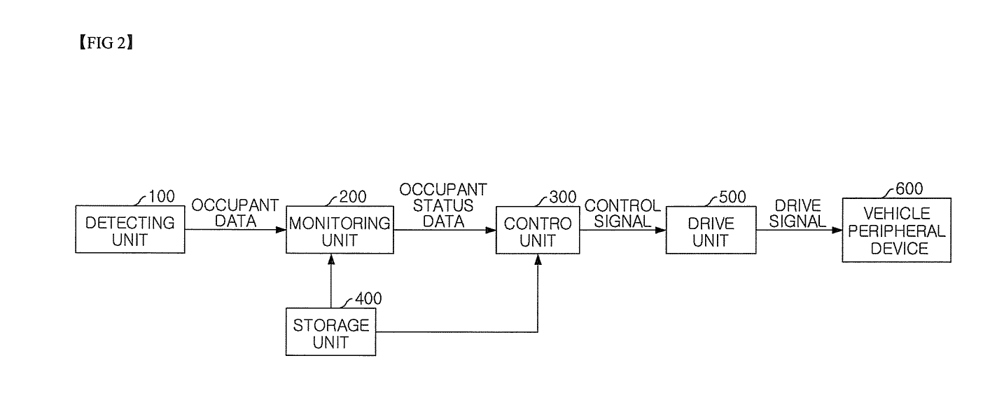

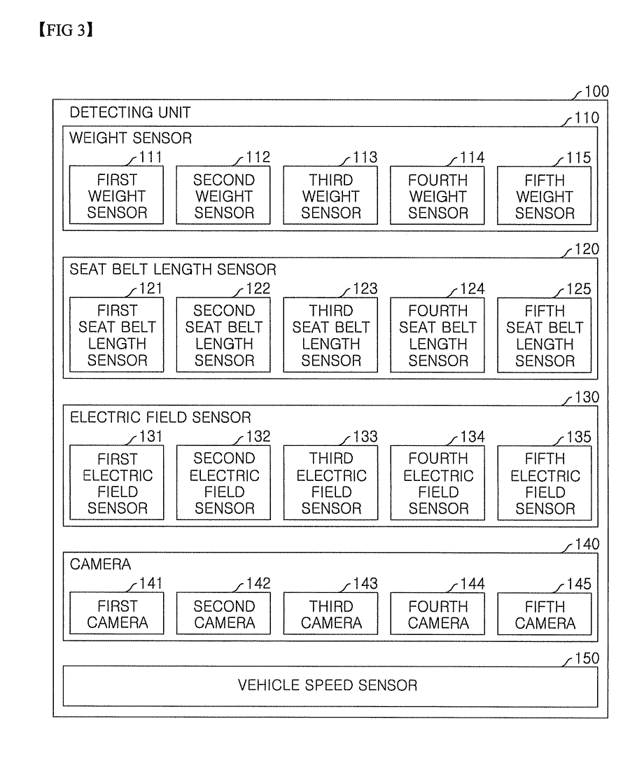

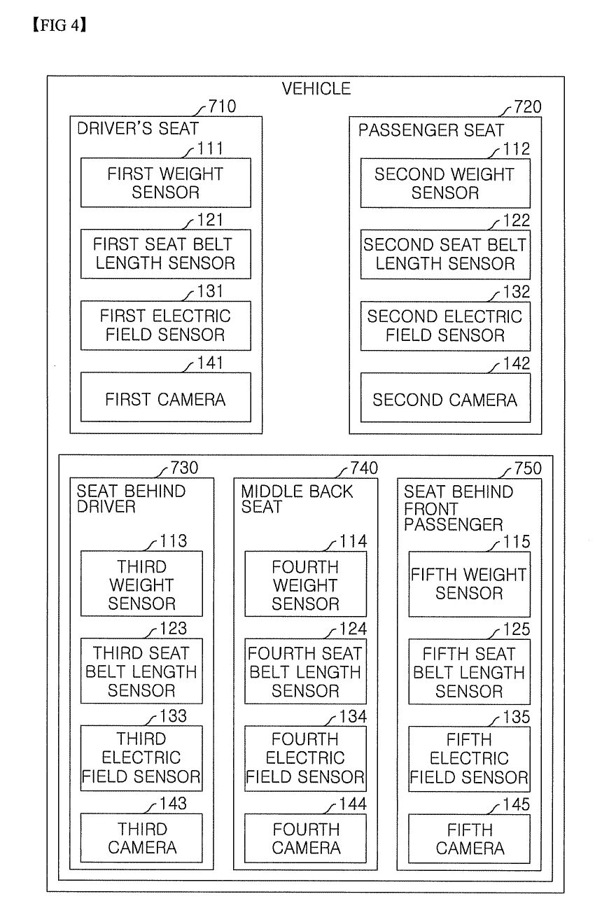

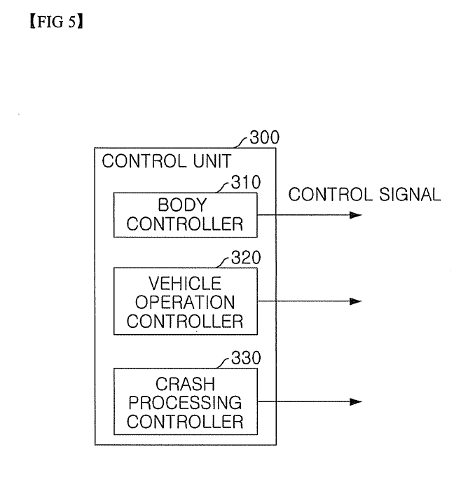

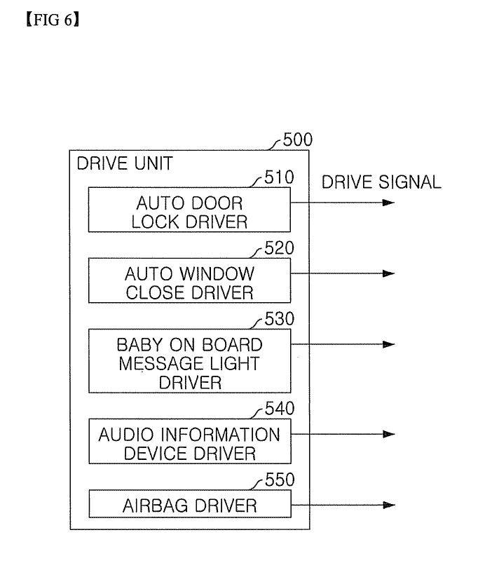

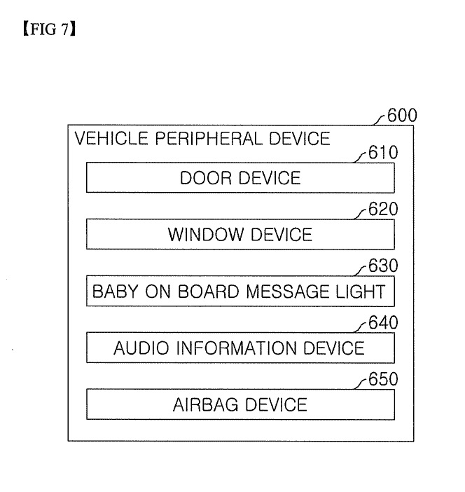

FIGS. 2 to 6 views of a control system for protecting child occupants of a vehicle according to an exemplary embodiment. FIG. 2 is a block diagram of a control system for protecting child occupants of a vehicle according to an exemplary embodiment, and FIG. 3 is a block diagram illustrating a detecting unit of FIG. 2, and FIG. 4 is a block diagram of occupant detection sensors installed in seats of the vehicle, and FIG. 5 is a block diagram illustrating a control unit of FIG. 2, and FIG. 6 is a block diagram illustrating a drive unit of FIG. 2, and FIG. 7 is a block diagram illustrating peripheral devices of the vehicle of FIG. 2.

Referring to FIG. 2, a control system for protecting child occupant of a vehicle according to an exemplary embodiment includes a detecting unit 100, a monitoring unit 200, a control unit 300, a storage unit 400, a drive unit 500, and vehicle peripheral devices 600.

The detecting unit 100 detects occupant data including the weight of occupants, whether an occupant has a seat belt on, and a deployed length of the seat belt to transmit the generated data to the monitoring unit 200.

The monitoring unit 200 determines whether the occupant is a child, whether the occupant has a seat belt fastened, and an occupant position based on the received occupant data to generate occupant status data based on the determined results and transmit the generated occupant status data to the control unit 300.

The control unit 300 outputs a control signal for controlling the drive unit 500 based on the received occupant status data.

The storage unit 400 stores a range of a seat belt usable length for adults, a range of a seat belt usable length when a child seat is installed, a range of a seat belt usable length for children, a range of an adult head position, a reference weight that becomes a criterion for determining whether the occupant is an adult, a reference speed for safe driving, and an open degree and reference operation speed of a window.

Each of the ranges of the seat belt usable lengths denotes an average range of seat belt usable lengths measured for ordinary adults and children. The range of the adult head position denotes an average range of adult heights when seated.

The reference weight that becomes the criterion for determining whether the occupant is an adult denotes an average weight measured for ordinary adults.

The reference speed for safe driving may be a speed limit for each road, a speed limit voluntarily set by a user, or a variable range for driving speeds (for example, speed variation parameters for rapid deceleration and rapid acceleration).

The open degree of the window is a value that limits an open degree of a window at a seat occupied by a child, in order to prevent the child from extending body parts out from the window.

The reference operation speed of the window is a reference speed for adjusting a window operation speed to slowly operate the window at the seat on which a child is seated when the child opens the window.

The drive unit 500 outputs a drive signal for driving each of the peripheral devices 600 such as the vehicle window according to the control signal.

Hereinafter, configurations of the detecting unit 100 will be described in detail with reference to FIG. 3.

The detecting unit 100 includes a weight sensor 110, a seat belt length sensor 120, an electric field sensor 130, a camera 140, and a vehicle speed sensor 150.

The weight sensor 110 includes a plurality of weight sensors, e.g., a first weight sensor 111, a second weight sensor 112, a third weight sensor 113, a fourth weight sensor 114, and a fifth weight sensor 115, which are respectively disposed in respective seats and the middle of the back seat in a vehicle to detect the weight of occupants in the respective seats.

The seat belt length sensor 120 determines whether each seat belt installed in the vehicle is fastened and measures a deployed length of each of the seat belts when fastened. The seat belt length sensor 120 includes a first seat belt length sensor 121, a second seat belt length sensor 122, a third seat belt length sensor 123, a fourth seat belt length sensor 124, and a fifth seat belt length sensor 125, which are respectively installed in the seats. The seat belt length sensor 120 detects whether the occupant seated on each of seats fastens the seat belt and the deployed length when fastened.

The seat belt length sensor 120 may not additionally detect whether the seat belt is fastened, but detects only the deployed length of the seat belt to transmit the detected result to the monitoring unit 200. The monitoring unit 200 may determine that the seat belt is not fastened when the pulled-out length of the seat belt is zero.

The electric field sensor 130 includes one or more electric field sensors, e.g., a first electric field sensor 131, a second electric field sensor 132, a third electric field sensor 133, a fourth electric field sensor 134, and a fourth electric field sensor 135, which respectively detect electric fields from occupants seated in the respective seats and the middle back seat. The electric field sensor 130 detects the electric field generated from a body of the occupant seated in each of the seats to determine whether an object is a person using the detected result.

In addition, since adults, infants, and children have slightly different electric field emission densities, it may determine whether an object is a person and whether the occupying object is an adult or child by detecting the emitted electric filed.

The camera 140 includes one or more cameras and photographs the respective seats and the middle back seat. One camera may be provided, or the camera 140 may include a first camera 141, a second camera 142, a third camera 143, a fourth camera 144, and a fifth camera 145, which are assigned to each of the seats. The camera 140 photographs the head position of the occupant seated in each of the seats within the previously set range of the adult head position.

The vehicle speed sensor 150 detects the traveling speed of the vehicle.

Referring to FIG. 4, the sensors of the detecting unit 100 are installed at the seats, e.g., a driver's seat 710, a passenger seat 720, a seat behind driver 730, the middle back seat 740, and a seat behind front passenger 750, respectively, and obtain data on the occupants of each seat.

According to this embodiment, the first weight sensor 111, the first seat belt length sensor 121, the first electric field sensor 131, and the first camera 141 are installed at the driver's seat 710.

The second weight sensor 112, the second seat belt length sensor 122, the second electric field sensor 132, and the second camera 142 are installed at the passenger seat 720.

The third weight sensor 113, the third seat belt length sensor 123, the third electric field sensor 133, and the third camera 143 are installed at the seat behind driver 730.

The fourth weight sensor 114, the fourth seat belt length sensor 124, the fourth electric field sensor 134, and the fourth camera 144 are installed at the middle back seat 740.

The fifth weight sensor 115, the fifth seat belt length sensor 125, the fifth electric field sensor 135, and the fifth camera 145 are installed at the seat behind front passenger 750.

For example, when an occupant is seated on the passenger seat 720, the second weight sensor 112 detects the weight of the occupant in the passenger seat 720, the second seat belt length sensor 122 detects whether the occupant in the passenger seat 720 has a seat belt fastened and the deployed length of the seat belt, and the second electric field sensor 132 detects an electric field around the passenger seat 720.

In addition, the second camera 142 may photograph a head position of the occupant seated in the passenger seat 720.

At this time, since the second camera 142 photographs the head position of the occupant only within the previously set range of the adult head position, when the occupant is a child, the second camera 142 does not photograph the head position of the occupant. As a result, the occupant can be distinguished as an adult or child through the photographed image.

The detecting unit 100 transmits the occupant data, which are detected or measured in each of the sensors 110, 120, 130, 140, and 150, including the occupant weight, whether the seat belt is fastened and the deployed length of the seat belt, the electric field density, and the head position and the vehicle speed data to the monitoring unit 200.

The monitoring unit 200 determines an occupant's seated position based on weight data with respect to each of the seats included in the received occupant data.

The monitoring unit 200 determines whether the occupant is an adult or child according to whether the detected deployed length of the seat belt is within the previously set range (e.g., about 100 cm to about 120 cm in the front seats and about 50 cm to about 60 cm in the rear seats) of the seat belt usable length for adults, where the seat belt is fastened at the detected occupant position. Also, the monitoring unit 200 determines whether the weight of the occupant detected at the corresponding position is less than the previously stored reference weight that becomes the criterion for determining whether the occupant is an adult.

When the occupant is a child, the monitoring unit 200 determines that the occupant is a child when the detected deployed length of the seat belt is within the range (e.g., about 50 cm to about 60 cm in the front seats and about 30 cm to about 35 cm in the rear seats) of the seat belt usable length in the case where a child seat is installed. Also, the monitoring unit 200 determines whether the detected deployed length of the seat belt is within the range (e.g., about 80 cm to about 90 cm in the front seats and about 40 cm to about 50 cm in the rear seats) of the seat belt usable length for children to generate occupant status data in which the results are reflected.

According to the previously-described methods, when the occupant fastens the seat belt, it may be determined whether an occupant is a child and whether a child seat is installed, using the deployed length of the seat belt and the weight applied to the seat.

When the occupant does not fasten a seat belt, i.e., when the weight of the occupant is detected by the weight sensor, but the deployed length of the seat belt is detected as zero by the seat belt length sensor, a “fasten seat belt” voice message may be provided or a “fasten seat belt” visual message may be displayed on a dashboard.

However, when the occupant does not fasten the seat belt in spite of the voice message or the visual message, additional data obtained from the electric field sensor or the camera may be used to distinguish whether an occupying object is a person and whether the occupant is an adult or child.

The data obtained from the electric field sensor or the camera may be also used when the occupant fastens the seat belt to improve reliability when the monitoring unit 200 distinguishes whether an object is a person and whether the person is an adult or child.

The monitoring unit 200 transmits the generated occupant status data to the control unit 300.

The occupant status data may include the following data:
1. Whether a child seat is installed and a position of the seat at which the child seat is installed.
2. A position of a seat on which a child is seated and whether the child has fastened the seat belt.
3. A position of a seat on which an adult is seated and whether the adult has fastened the seat belt.
4. A position of a seat on which an object is placed and whether the seat belt is fastened to the object.

The monitoring unit 200 continuously generates or periodically renews the occupant status data by a preset period based on the occupant data transmitted from the detecting unit 100.

When the monitoring unit 200 renews the occupant status data by the preset period, the preset period denotes an average movement time (about ten minutes) at an average speed obtained by measuring the moving speed of an ordinary child.

Referring to FIG. 5, the control unit 300 includes a body controller 310, a vehicle operation controller 320, and a crash processing controller 330.

The body controller 310 outputs control signals for controlling door and window operations, at a seat in which the child is seated, among doors (e.g., a door device 610) and windows (e.g., window device 620) included in the vehicle peripheral devices 600 and an operation of a baby on board message light 630 included in the vehicle peripheral devices 600 when the child occupant is detected based on the occupant status data received from the monitoring unit 200.

Based on the occupant status data, when the occupant does not fasten the seat belt, the body controller 310 outputs control signals for controlling an audio system or an auxiliary audio device 640 included in the vehicle peripheral devices 600.

For example, when a child occupant is in the vehicle, the body controller 310 switches the door and window of the seat in which the child is seated to an automatic locked state during driving, or limits an open degree of the window. Particularly, although the child does not fasten the seat belt, the door and window may be switched to the automatic locked state. In addition, when the child fastens the seat belt, only the open degree of the window may be limited.

The body controller 310 may allow an operation speed (opening speed) of a power window to be slower than a reference operation speed when a child pushes a window button.

When a child is seated in the middle back seat 740, in consideration of active movement of a child, the body controller 310 may switch all left and right doors and windows of the back seat to the automatic locked state when it is determined that the child does not fasten the seat belt.

The body controller 310 may control operations of various vehicle peripheral devices 600 to protect the child.

Since the control operations are applied to only children, adults may operate the doors and windows without experiencing discomfort.

When a child or an adult does not fasten the seat belt, the body controller 310 may announce a “fasten seat belt” voice message to the occupant to guide wearing seat belt.

When the traveling speed of a vehicle rapidly changes (e.g., through rapid acceleration, rapid deceleration, and exceeding the speed limit) over a preset reference speed for safe driving, the vehicle operation controller 320 outputs a control signal for controlling the car audio included in the vehicle peripheral devices 600, i.e., the audio information device 640.

For example, when a child occupant is in the vehicle, the vehicle operation controller 320 announces that the child is on board to the driver to encourage the driver to safely drive the vehicle, at times when rapid acceleration, rapid deceleration, speeding, or a sudden lane change occurs due to driving habits of the driver.

When an accident occurs, the crash processing controller 330 outputs control signals for controlling an operation of an airbag device 650 included in the vehicle peripheral devices 600, e.g., whether an additional airbag is operated and whether to adjust the amount of air for an airbag.

The crash processing controller 330 may control the airbag device 650 using the head position data of the occupant when the airbag device 650 is controlled.

For example, when the accident occurs, damage is generally reduced by the airbag. However, when an infant or child is in a vehicle, and particularly, when the infant or child is seated in the passenger seat 720, more damage may be inflicted. Thus, the crash processing controller 330 may confirm a child's occupancy included in the occupant status data for each of the seats to control the operation of the airbag device 650 according to the child occupancy status.

For example, when a child seat is installed in the passenger seat 720, or the child fastens a seat belt, the crash processing controller 330 may adjust the amount of deploying gas in the front passenger side airbag and operate a side airbag. When the child does not fasten the seat belt, the crash processing controller 330 may direct the airbag device 650 toward the windshield.

When a child seat is installed in the seat behind front passenger 750, or the child fastens the seat belt, the crash processing controller 330 may operate an airbag on the rear of the front passenger seat and a side airbag and adjust the amount of the gas in the airbag. When the child seat is installed on the middle back seat 740, or the child does not fasten the seat belt, the crash processing controller 330 may allow an airbag to operate between the driver's seat 710 and the passenger seat 720.

When an infant or child that is seated on the back seats does not fasten the seat belt, the crash processing controller 330 may operate all airbags such as a windshield airbag (which may prevent an infant or child from being thrown out from the front windshield through a space between the driver's seat 710 and the passenger seat 720) side airbags, and a seatback rear airbag.

To control the airbags, it may be important to use data with respect to the head position of the occupant detected by the camera 140. Even when an occupant is determined to be a child based on the deployed length of a seat belt and the weight of an occupant, when the head position of the occupant corresponds to a head position of an adult based on head position data obtained by the camera 140, the airbags may be adjusted to a reference state for an adult. This is done for the reason that it may be appropriate to control the airbag in the reference state for an adult during a car accident when the head position of the child is high.

Referring to FIG. 6, the drive unit 500 includes an auto door lock driver 510, an auto window close driver 520, a baby on board message light driver 530, an audio information device driver 540, and an airbag driver 550.

The drive unit 500 receives a control signal of the control unit 300 to operate each of the drivers 510, 520, 530, 540, and 550, thereby outputting a drive signal for operating the vehicle peripheral devices 600.

The vehicle peripheral devices 600 may be directly controlled by the control signal outputted from the control unit 300. The drive unit 500 may receive the control signal to output the drive signal for operating the vehicle peripheral devices 600 according to the control signal.

Referring to FIG. 7, the vehicle peripheral devices 600 include a door lock device, a window opening/closing device, a baby on board message light 630, an audio information device 640, and an airbag device 650.

For example, when the vehicle peripheral device 600 is operated according to the control signal of the control unit 300, the vehicle peripheral device 600 operates a door, a window, the baby on board message light 630, the audio information device 640, and the airbag device 650 according to the control signal of the control unit 300.

When the vehicle peripheral device 600 is operated according to the drive signal of the drive unit 500, the vehicle peripheral device 600 operates a door device 610, a window device 620, the baby on board message light 630, the audio information device 640, and the airbag device 650 according to the drive signal of the drive unit 500.

A case in which the vehicle peripheral device 600 is operated according to the control signal of the control unit 300 will be described again as an example.

A door of a seat on which a child is seated is switched to a locked state according to a control signal of the body controller 310.

A window of the seat on which the child is seated is switched to a locked state, and an open degree of the window is limited according to the control signal of the body controller 310. In addition, when the window is operated by a child's manipulation, the window is opened at a speed slower than a reference speed.

The baby on board message light 630 is turned on/off according to the control signal of the body controller 310.

The car audio or the auxiliary audio device 640 announces a “fasten seat belt” voice message according to the control signal of the body controller 310.

Also, the car audio or the auxiliary audio device 640 emits a “baby on board” voice message according to a control signal of the vehicle operation controller 320.

The airbag device 650 adjusts an amount of gas in a front airbag or operates side airbags according to a control signal of the crash processing controller 330.

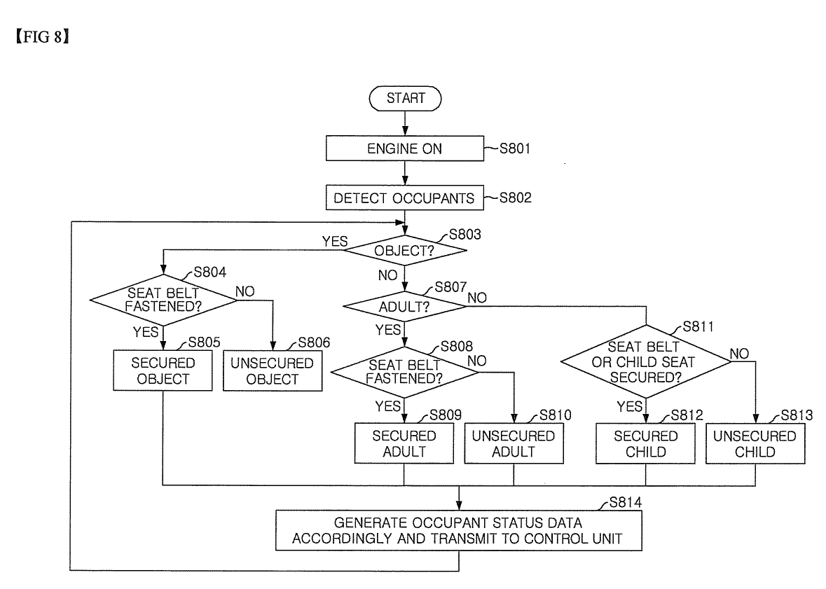

FIG. 8 is a flowchart illustrating a process for distinguishing occupants and occupant statuses through a monitoring unit according to an exemplary embodiment.

Referring to FIG. 8, when a vehicle is started in step S801, a monitoring unit 200 receives occupant data detected by a detecting unit 100 in step S802.

In step S803, the monitoring unit 200 determines an object's (occupant's) seated position based on the received occupant data and determines whether an object is inanimate.

When the object is determined to be inanimate, the monitoring unit 200 determines whether the object has a seat belt fastened, based on the occupant data in step S804.

When the object has a seat belt fastened, the monitoring unit 200 determines that the occupant is a safe object in step S805.

However, when the object does not have a seat belt fastened, the monitoring unit 200 determines that the occupant is an unsafe object in step S806.

When the result of step S803 is negative, the monitoring unit 200 determines whether the occupant is an adult based on the occupant data in step S807.

When the occupant is determined to be an adult, the monitoring unit 200 determines whether the adult has fastened a seat belt in step S808.

When the adult is determined to have fastened the seat belt, the monitoring unit 200 determines that the occupant is a safe adult in step S809.

When the adult has not fastened the seat belt, the monitoring unit 200 determines that the occupant is an unsafe adult in step S810.

When the result at step S807 is negative, the monitoring unit 200 determines that the occupant is a child and whether the child has fastened a seat belt or whether a child seat has been installed in step S811.

When the child is determined to have fastened a seat belt, or a child seat has been installed, the monitoring unit 200 determines that the occupant is a safe child in step S812.

When the child is found not to have fastened a seat belt, or the child seat has not been installed, the monitoring unit 200 determines that the occupant is an unsafe child in step S813.

In step S814, the monitoring unit 200 reflects the determined occupant data to generate occupant status data and transmits the generated occupant status data to the control unit 300.

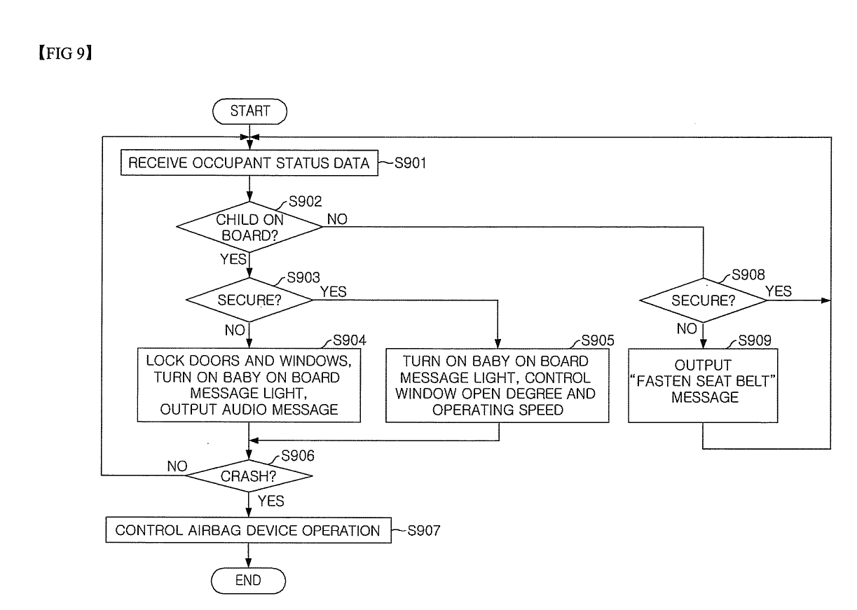

FIG. 9 is a flowchart illustrating a control method for protecting a child of a vehicle according to an exemplary embodiment.

Referring to FIG. 9, the control unit 300 receives the occupant status data from the monitoring unit 200 in step S901.

When the control unit 300 determines that an occupant is a child in step S902 and the child is in an unsafe state in step S903 based on the received occupant status data, the control unit 300 switches a door and window at a seat in which the child is seated to a locked state and limits an open degree of the window at the seat in which the child is seated. In addition, when the window is operated by a child's manipulation, the control unit 300 opens the window at a speed slower than a reference speed and turns on the baby on board message light 630 in step S904.

However, when the control unit 300 determines that the occupant is the child in step S902 and the child is in a safe state in step S903 based on the received occupant status data, the control unit 300 limits the open degree of the window at which the child is seated. In addition, when the window is operated by the child's manipulation, the control unit 300 opens the window at the speed slower than the reference speed and turns on the baby on board message light 630 in step S905.

In step S906, the control unit 300 determines whether a car accident occurs during driving. When a car accident occurs, the control unit 300 controls the airbag device 650 to adjust the amount of the gas in the front passenger side airbag or operate the side airbags in step S907.

However, in step S902, when the control unit 300 determines that the occupant is not a child but an adult in step S902, and the adult is in an unsafe state in step S908 based on the received occupant status data, the control unit 300 announces a “fasten seat belt” voice message through the audio information device 640 in step S909.

When the control unit 300 determines that object occupying the seat is inanimate, based on electric field data detected by the electric field sensor, the control unit 300 does not proceed to the previously described steps (S902 to S909).

That is, if the electric field sensor does not detect that an object on a seat is a person or an inanimate object, when the control unit 300 determines whether an occupant is a child based on the deployed length of a seat belt or the weight of the occupant, the control unit 300 may recognize the object as a child when it is, in fact, a small object such as a bag or luggage on the seat. As a result, the control unit 300 may unnecessarily control doors, windows, and airbags. Thus, the control unit 300 proceeds to the step S803 to determine whether an object on the seat is a person or object. Then, when the object is found to be inanimate, the control unit 300 may not control the doors, the windows, and the airbags.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A control system for protecting child occupants of a vehicle, comprising:
a detecting unit detecting occupant data comprising weights of occupants and deployed lengths of seat belts;
a monitoring unit determining whether the occupants are children, whether the occupants have fastened seat belts, and occupant positions based on the detected occupant data to generate occupant status data according to the determined results; and
a control unit controlling a vehicle peripheral device according to the occupant status data when the occupant status data is received.

2. The control system of claim 1, wherein the detecting unit comprises a plurality of weight sensors and a plurality of seat belt length sensors, which are installed at each seat of the vehicle,
wherein the plurality of weight sensors detects the weights of the occupants of each of the seats, and the plurality of seat belt length sensors detects a deployed lengths of seat belts for the occupants of each of the seats.

3. The control system of claim 2, wherein the monitoring unit determines that the occupants are children when the deployed lengths of the seat belts are less than a range of a seat belt usable length for adults, and the weights of the occupants are less than a reference weight.

4. The control system of claim 1, wherein the detecting unit further comprises one or more cameras that photograph head positions of the occupants of each of the seats within an adult head position capturing range of each of the cameras.

5. The control system of claim 4, wherein the monitoring unit determines whether the occupants are children using additional data with respect to the head positions of the photographed occupants.

6. The control system of claim 1, wherein the detecting unit further comprises one or more electric field sensors that detect electric field generated from bodies of the occupants of each of the seats.

7. The control system of claim 6, wherein the monitoring unit determines whether the occupants are people or objects, based on the detected electric fields to generate occupant status data in which the determined result is reflected.

8. The control system of claim 1, wherein the control unit comprises a body controller that performs at least one of a door lock, a window lock, a window open degree limiting, a window opening/closing speed reduction, and a “baby on board” message lighting, when the control unit determines that the occupants are children, based on the occupant status data.

9. The control system of claim 8, wherein the body controller outputs a control signal for issuing a voice message through an audio system of the vehicle when the occupants have not fastened seat belts.

10. The control system of claim 1, wherein the control unit comprises a vehicle operation controller that outputs a control signal for issuing a “baby on board” voice message through an audio system of the vehicle when a traveling speed of the vehicle rapidly exceeds a preset reference speed for safe driving, when the control unit determines that the occupants are children, based on the occupant status data.

11. The control system of claim 1, wherein the control unit comprises a crash processing controller that outputs a control signal for controlling an airbag device that constitutes the vehicle peripheral device, based on the occupant status data when an accident occurs.

12. A control method for protecting child occupants of a vehicle, the control method comprising:
obtaining occupant data comprising weights of occupants and deployed lengths of seat belts;
determining whether the occupants are children, whether the occupants have fastened seat belts, and occupant positions based on the obtained occupant data, and generating occupant status data according to the determined results; and
controlling a vehicle peripheral device according to the generated occupant status data.

13. The control method of claim 12, wherein the obtaining of the occupant data comprises:
detecting the weight of the occupants of each seat; and
detecting deployed lengths of a seat belts for the occupants of each of the seats.

14. The control method of claim 13, wherein the generating of the occupant status data comprises:
determining occupant seated positions based on weight data of the occupants for each of the seats, contained in the detected occupant data.
determining whether the deployed lengths of the seat belts are less than a range of a seat belt usable length for adults, and the weights of the occupants are less than a reference weight; and
determining whether the occupants are adults or children, according to the determined results.

15. The control method of claim 14, wherein the obtaining of the occupant data further comprises detecting head positions of the occupants, and the generating of the occupant status data further comprises adding data on the detected head position to generate the occupant status data.

16. The control method of claim 12, wherein the controlling of the vehicle peripheral device comprises:
determining whether the occupants are children, based on the occupant status data;
locking a door and a window at seats with occupants when the occupants are children, from among doors and windows constituting the vehicle peripheral device; and
outputting a “fasten seat belt” voice message when the occupants have not fastened seat belts, based on the occupant status data.

17. The control method of claim 12, wherein the controlling of the vehicle peripheral device comprises:
determining whether the occupants are children and whether the occupants have fastened seat belts;
limiting an open degree and an opening/closing speed of windows of the vehicle when the occupants are children and the occupants have fastened seat belts; and
locking doors and windows of the vehicle when the occupants are children and the occupants have not fastened seat belts.

18. The control method of claim 12, wherein the controlling of the vehicle peripheral device further comprises enabling an airbag device that constitutes the vehicle peripheral device to adjust a volume of deployment gas for a front airbag, or operate side airbags, when child occupants are in the vehicle and an accident occurs.

19. The control method of claim 12, wherein the controlling of the vehicle peripheral device comprises outputting a “baby on board” voice message when a traveling speed of the vehicle rapidly exceeds a preset reference speed, when child occupants are determined to be in the vehicle.

20. The control method of claim 12, wherein the generating of the occupant status data further comprises determining whether objects occupying each of the seats are people, and the controlling of the vehicle peripheral device is performed only when the objects are determined to be people.
